(19) United States
(12) Patent Application Publication
(10) Pub. No.: US 2009/0225113 A1
(43) Pub. Date: Sep. 10, 2009

(54) METHOD OF DRIVING A LIQUID JET HEAD AND A LIQUID JET APPARATUS

(75) Inventor: Shiro Yazaki, Chino-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/395,419

(22) Filed: Feb. 27, 2009

(30) Foreign Application Priority Data
Feb. 28, 2008 (JP) 2008-048751
Jan. 8, 2009 (JP) 2009-002956

(51) Int. Cl. B41J 29/38; B41J 2/045

(52) U.S. Cl. 347/10; 347/72

(57) ABSTRACT

Disclosed is a driving method. When the main piezoelectric element is driven so as to jet liquid droplets from a predetermined nozzle, a driving signal which is in opposite phase to a driving signal to be applied to the main piezoelectric element is applied to a sub piezoelectric element corresponding to a sub pressure chamber communicating with a nozzle, which does not jet liquid droplets.

### CROSS REFERENCES TO RELATED APPLICATIONS

The present application claims priority to Japanese Patent Application No. 2008-48751 filed in the Japanese Patent Office on Feb. 28, 2008 and Japanese Patent Application No. 2009-2956 filed in the Japanese Patent Office on Jan. 8, 2009, the entire contents of which are incorporated herein by reference.

### BACKGROUND OF THE INVENTION

1. Field of the Invention

The present invention relates to a method of driving a liquid jet head and a liquid jet apparatus.

2. Description of the Related Art

If the arrangement density of nozzles increases, the section area of each pressure generation chamber decreases. The decrease in the section area of each pressure generation chamber causes deterioration of the ink supply characteristic of the pressure generation chamber. That is, in order to secure a necessary volume of the pressure generation chamber, the length of the pressure generation chamber increases as the section area decreases. The increase in the length of the pressure generation chamber causes deterioration of the ink supply characteristic of the pressure generation chamber. When this happens, for example, the Helmholtz vibration cycle Tc of the pressure generation chamber is lengthened or the return of a meniscus toward a nozzle opening is delayed. As a result, it may be impossible to increase a driving frequency.

In order to solve such a problem, for example, JP-A-2003-276199 suggests an ink jet type recording head that has a plurality of communicating grooves (sub pressure chambers) communicating with the pressure generation chambers (main pressure chamber). In such an ink jet type recording head, auxiliary piezoelectric elements are individually provided in regions corresponding to the communicating grooves.

In the ink jet type recording head described in Patent Document 1, ink droplets are ejected by displacement of the piezoelectric elements. In this case, the auxiliary piezoelectric elements provided in the regions opposite the communicating grooves are selectively displaced, and accordingly ink droplets are jet from a predetermined nozzle. That is, when ink droplets are jet, an auxiliary piezoelectric element corresponding to a nozzle which jets ink droplets is displaced, and compliance of a vibrating plate on the corresponding communicating groove decreases. Meanwhile, an auxiliary piezoelectric element corresponding to a nozzle which does not jet ink droplets is not displaced, and compliance of a vibrating plate on the corresponding communicating groove is maintained so as to be comparatively high.

With such a driving method, while the driving frequency increases, ink droplets may be selectively jet from a predetermined nozzle. However, only by changing compliance of the vibrating plate, it is impossible to control a pressure given to ink when a piezoelectric element is driven. As a result, ink droplets may be simultaneously jet from the nozzles.

### SUMMARY OF THE INVENTION

The invention has been finalized in order to solve at least some of the above-described problems, and it may be realized by the following aspects or examples.

An aspect of the invention provides a method of driving a liquid jet head. The liquid jet head includes a plurality of nozzles jetting liquid droplets, pressure generation chambers individually communicating with the nozzles and having a predetermined width, a reservoir common to a plurality of pressure generation chambers, and piezoelectric elements, each causing a change in pressure of a corresponding one of the pressure generation chambers. Each of the pressure generation chambers includes a main pressure chamber communicating with the reservoir through a liquid supply channel, and a plurality of sub pressure chambers arranged in parallel in a width direction of the main pressure chamber, the sub pressure chambers independently communicating with an end surface of the main pressure chamber opposite to the liquid supply channel, and each of the sub pressure chambers communicating with the corresponding nozzle. Each of the piezoelectric elements includes a main piezoelectric element provided to correspond to the main pressure chamber, and sub piezoelectric elements provided to correspond to the sub pressure chambers and to have a width smaller than that of the main piezoelectric element. When the main piezoelectric element is driven so as to jet liquid droplets from a predetermined nozzle, a driving signal which is in opposite phase to a driving signal to be applied to the main piezoelectric element is applied to a sub piezoelectric element corresponding to a sub pressure chamber communicating with a nozzle, which does not jet liquid droplets.

The above and other features and objects of the invention will become apparent from the following description with reference to the accompanying drawings.

### BRIEF DESCRIPTION OF THE DRAWINGS

For better understanding of the invention and its advantages, reference will be made in the following description and the accompanying drawings.

FIG. 1 is a schematic perspective view of a recording apparatus according to an embodiment of the invention.

FIG. 2 is an exploded perspective view of a recording head according to an embodiment of the invention.

FIG. 3 is a plan view and a sectional view of a recording head according to an embodiment of the invention.

FIG. 4 is a block diagram showing the configuration of a recording apparatus according to an embodiment of the invention.

FIG. 5 is a diagram showing an example of basic driving signals.

FIG. 6 is a diagram showing patterns of driving signals.

FIG. 7 is a diagram showing patterns of driving signals.

### DETAILED DESCRIPTION OF THE PREFERRED EMBODIMENT

At least the following will become apparent from the description herein and the accompanying drawings.

An aspect of the invention provides a method of driving a liquid jet head. The liquid jet head includes a plurality of nozzles jetting liquid droplets, pressure generation chambers individually communicating with the nozzles and having a predetermined width, a reservoir common to a plurality of pressure generation chambers, and piezoelectric elements, each causing a change in pressure of a corresponding one of the pressure generation chambers. Each of the pressure generation chamber includes a main pressure chamber communicating with the reservoir through a liquid supply channel, and a plurality of sub pressure chambers arranged in parallel in a width direction of the main pressure chamber, the sub pressure chambers independently communicating with an end surface of the main pressure chamber opposite to the liquid supply channel, and each of the sub pressure chamber communicating with a corresponding one of the nozzles. Each of the piezoelectric elements includes a main piezoelectric element provided to correspond to the main pressure chamber, and sub piezoelectric elements provided to correspond to the sub pressure chambers and to have a width smaller than that of the main piezoelectric element. When the main piezoelectric element is driven so as to jet liquid droplets from a predetermined nozzle, a driving signal which is in opposite phase to a driving signal to be applied to the main piezoelectric element is applied to a sub piezoelectric element corresponding to a sub pressure chamber communicating with a nozzle, which does not jet liquid droplets.

In a method of driving a liquid jet head according to another aspect of the invention, a driving signal in opposite phase to a driving signal to be applied to the main piezoelectric element is applied to a sub piezoelectric element. Therefore, no liquid droplets are jet from a nozzle corresponding to the sub piezoelectric element, and liquid droplets are selectively jet from another nozzle.

The sub piezoelectric elements may be separately driven so as to jet liquid droplets of a first size, the main piezoelectric element may be separately driven so as to jet liquid droplets of a second size larger than the first size, and the main piezoelectric element and the sub piezoelectric elements may be simultaneously driven so as to jet liquid droplets of a third size larger than the second size.

In this way, if liquid droplets having a plurality of sizes are jet, a liquid jet head is used for various purposes.

The sub piezoelectric elements may be driven by a voltage higher than a voltage to be applied to the main piezoelectric element.

That is, the main piezoelectric element and the sub piezoelectric elements are driven by voltages depending on the sizes (widths) of the main piezoelectric element and the sub piezoelectric elements, respectively.

Therefore, an adequate pressure depending on the size of the pressure chamber is given to the liquid, and thus liquid droplets are satisfactorily jet from a predetermined nozzle.

Another aspect of the invention provides a liquid jet apparatus. The liquid jet apparatus includes a liquid jet head and a driving control unit. The liquid jet head includes a plurality of nozzles jetting liquid droplets, pressure generation chambers individually communicating with the nozzles and having a predetermined width, a reservoir common to a plurality of pressure generation chambers, and piezoelectric elements, each causing a change in pressure of a corresponding one of the pressure generation chambers. Each of the pressure generation chambers includes a main pressure chamber communicating with the reservoir through a liquid supply channel, and a plurality of sub pressure chambers arranged in parallel in a width direction of the main pressure chamber, the sub pressure chambers independently communicating with an end surface of the main pressure chamber opposite to the liquid supply channel, and each of the sub pressure chambers communicating with a corresponding one of the nozzles. Each of the piezoelectric elements includes a main piezoelectric element provided to correspond to the main pressure chamber, and sub piezoelectric elements provided to correspond to the sub pressure chambers and have a width smaller than that of the main piezoelectric element. When the main piezoelectric element is driven so as to jet liquid droplets from a predetermined nozzle, the driving control unit applies a driving signal, which is in opposite phase to a driving signal to be applied to the main piezoelectric element, to a sub piezoelectric element corresponding to a sub pressure chamber communicating with a nozzle, which does not jet liquid droplets.

In the liquid jet apparatus according to the invention, the driving control unit applies a driving signal, which is in opposite phase to a driving signal to be applied to the main piezoelectric element, to a sub piezoelectric element. Therefore, no liquid droplets are jet from a nozzle corresponding to the sub piezoelectric element, and liquid droplets are selectively jet from another nozzle.

Hereinafter, a preferred embodiment of the invention will be described with reference to the drawings. The following embodiment is described as an example of the invention, and all the parts to be described below are not always essential parts.

### Best Embodiment

Hereinafter, an embodiment will be described with reference to the drawings.

### First Embodiment

Hereinafter, the invention will be described in detail with reference to an embodiment.

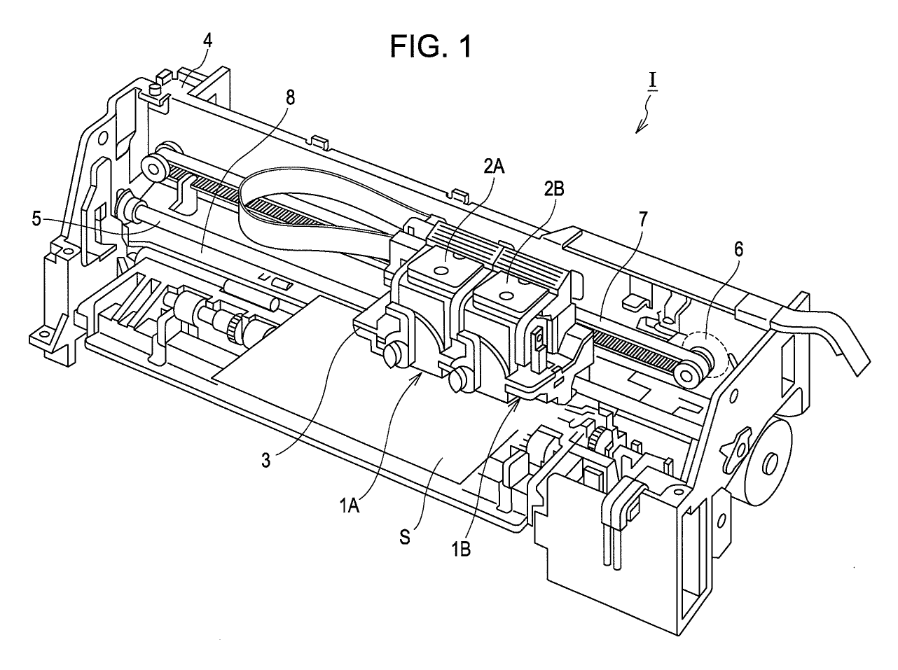

FIG. 1 is a perspective view showing the schematic configuration of an ink jet type recording apparatus, which is an example of a liquid jet apparatus.

As shown in FIG. 1, an ink jet type recording apparatus I is configured such that cartridges 2A and 2B constituting an ink supply unit are detachably mounted on recording head units 1A and 1B each having an ink jet type recording head (hereinafter, simply referred to as a recording head), which will be described below, respectively. A carriage 3 having mounted thereon the recording head units 1A and 1B is provided so as to freely move in an axial direction with respect to a carriage shaft 5 attached to an apparatus main body 4. The recording head units 1A and 1B eject a black ink composition and a color ink composition, respectively.

If a driving force of a driving motor 6 is transmitted to the carriage 3 through a plurality of gears (not shown) and a timing belt 7, the carriage 3 having mounted thereon the recording head units 1A and 1B moves along the carriage shaft 5. A platen 8 is provided in the apparatus main body 4 along the carriage shaft 3. A sheet discharge roller 9 is provided near the platen 8 so as to be rotatable by a driving force of a sheet feed motor (not shown). A recording sheet S that is a recording medium, such as paper or the like, fed by the sheet feed roller and the like, is transported.

In such an ink jet type recording apparatus I, the carriage 3 moves along the carriage shaft 5, and ink is ejected by the recording head units (recording head) 1A and 1B and printed on the recording sheet S.

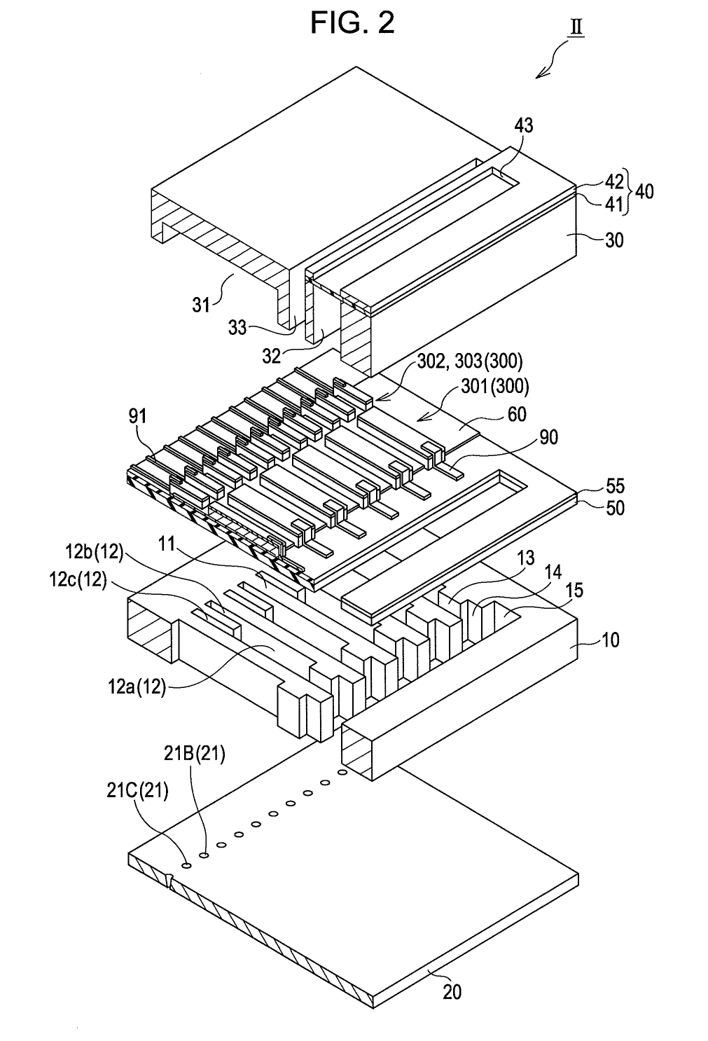

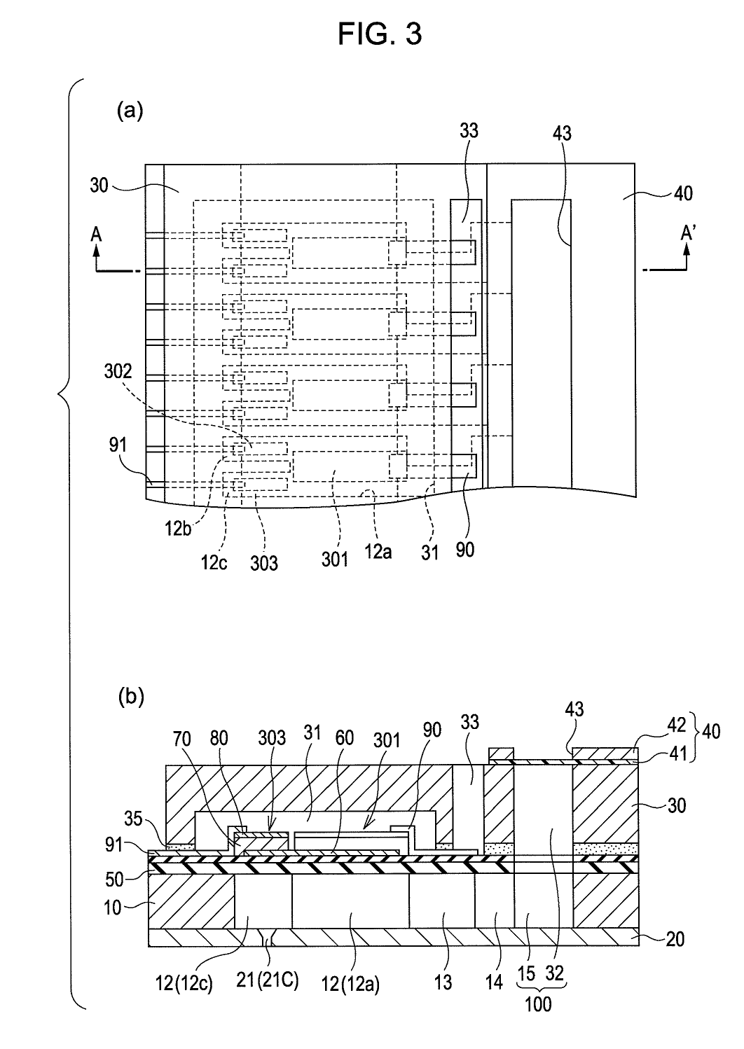

Next, the configuration of a recording head to be mounted on the above-described ink jet type recording apparatus I will be described. FIG. 2 is an exploded perspective view showing the schematic configuration of a recording head according to this embodiment. FIG. 3 is a plan view of FIG. 2 and a sectional view taken along the line A-A′ of FIG. 2.

As showing in FIG. 2 and FIG. 3, in this embodiment, a flow channel forming plate 10 constituting a recording head II flow channel forming plate 10 is made of a silicon monocrystal plate having a surface direction (110). An elastic film 50 made of silicon dioxide is formed on one surface of the flow channel forming plate 10 by thermal oxidization. Pressure generation chambers 12 which are partitioned by a plurality of partition walls 11 are provided in the flow channel forming plate 10 so as to be arranged in parallel in a width direction (lateral direction) of the flow channel forming plate 10. Ink supply channels 13 and communicating channels 14 are partitioned by the partition walls 11 at an end portion of the flow channel forming plate 10 in a longitudinal direction of each of the pressure generation chamber 12. A communicating portion 15 that constitutes a part of a reservoir 100 serving as a common ink chamber (liquid chamber) of the pressure generation chambers 12 is formed at one end of each of the communicating channels 14.

Each of the pressure generation chambers 12 includes a main pressure chamber 12a communicating with the corresponding ink supply channel 13, and two sub pressure chambers (first sub pressure chamber 12b and second sub pressure chamber 12c) arranged in parallel in a width direction of the main pressure chamber 12a to independently communicate with an end surface of the main pressure chamber 12a opposite to the ink supply channel 13. The sub pressure chambers 12b and 12c have a width smaller than that of the main pressure chamber 12a, and extend in a longitudinal direction of the main pressure chamber 12a.

A nozzle plate 20 is fixed onto an opening surface side of the flow channel forming plate 10 by an adhesive, a thermally welding film, or the like. The nozzle plate 20 is provided with nozzles 21 individually communicating with the sub pressure chambers 12b and 12c. The nozzle plate 20 is made of, for example, glass ceramics, a silicon monocrystal plate, stainless steel, or the like.

On a side opposite to the opening surface of the flow channel forming plate 10, as described above, the elastic film 50 is formed. An insulator film 55 is formed on the elastic film 50. Piezoelectric elements 300 each having a lower electrode film 60, a piezoelectric material layer 70, and an upper electrode film 80 are formed on the insulator film 55. Each of the piezoelectric elements 300 includes a main piezoelectric element 301 that is provided to be opposite the main pressure chamber 12a constituting the corresponding pressure generation chamber 12, and sub piezoelectric elements (first sub piezoelectric element 302 and second sub piezoelectric element 303) that are provided to correspond to the sub pressure chambers 12b and 12c. The main piezoelectric element 301 and the sub piezoelectric elements 302 and 303 are formed to correspond to the main pressure chamber 12a and the sub pressure chambers 12b and 12c so as to have widths smaller than those of the main pressure chamber 12a and the sub pressure chambers 12b and 12c, respectively. That is, the sub piezoelectric elements 302 and 303 that are provided to correspond to the sub pressure chambers 12b and 12c having a width smaller than that of the main pressure chamber 12a are formed so as to have a width smaller than that of the main piezoelectric element 301.

In this embodiment, the lower electrode film 60 forms a common electrode of the piezoelectric elements 300, and the upper electrode film 80 forms individual electrodes of the piezoelectric elements 300, but this configuration may be reversed depending on the specific arrangement of the driving circuit or wiring. Each piezoelectric element 300 and a vibrating plate where displacement occurs when the piezoelectric element 300 is driven are collectively called an actuator. The vibrating plate refers to a portion which forms one surface of the corresponding pressure generation chamber 12 and at which deformation occurs when the piezoelectric element 300 is driven. In this embodiment, the elastic film 50, the insulator film 55, and the lower electrode film 60 serve as the vibrating plate, but the invention is not limited thereto. For example, only the lower electrode film 60 may serve as a vibrating plate, while the elastic film 50 and the insulator film 55 may not be provided. Alternatively, the piezoelectric element 300 itself may serve as a vibrating plate.

A lead electrode 90 is connected to the upper electrode film 80 serving as the individual electrode of the main piezoelectric element 301. The lead electrode 90 is led from near an end portion in the longitudinal direction of the main piezoelectric element 301 to a region outside the pressure generation chamber 12. The lead electrode 90 is made of, for example, gold (Au) or the like. In this embodiment, the lead electrode 90 extends from near the end portion in the longitudinal direction of the piezoelectric element 300 to a region opposite a through portion 33 of a protective plate 30, and is connected to a driving IC or the like by a connection wire (not shown) which extends through the through portion 33.

Lead electrodes 91 are connected to the upper electrode films 80 serving as the individual electrodes of the sub piezoelectric elements 302 and 303, respectively. The lead electrodes 91 are led from near end portions in the longitudinal direction of the sub piezoelectric elements 302 and 303 to regions outside the sub pressure chambers 12b and 12c, respectively. The lead electrodes 91 extend to near the end portion of the flow channel forming plate 10, and are connected to a driving IC or the like by connection wires (not shown), similarly to the lead electrode 90.

A protective plate 30 is bonded onto the flow channel forming plate 10. The protective plate 30 is used to protect the piezoelectric elements 300 and has a piezoelectric element holding portion 31. The piezoelectric elements 300 are formed within the piezoelectric element holding portion 31, and thus they are protected without being almost influenced by an external environment. The piezoelectric element holding portion 31 may be sealed or unsealed. A reservoir portion 32 is provided in the protective plate 30 so as to constitute at least a part of the reservoir 100. In this embodiment, the reservoir portion 32 passes through the protective plate 30 in its thickness direction and extends along the width direction of the respective pressure generation chambers 12. The reservoir portion 32 communicates with the communicating portion 15 of the flow channel forming plate 10 and constitutes the reservoir 100 serving as the ink chamber common to the pressure generation chamber 12. The through portion 33 is provided in a region of the protective plate 30 between the piezoelectric element holding portion 31 and the reservoir portion 32 to pass through the protective plate 30 in its thickness direction. As described above, near the end portions of the lead electrodes 90 led from the respective piezoelectric elements 300 are exposed through the through portion 33. The protective plate 30 is made of, for example, glass, a ceramics material, a metal, resin, or the like. Preferably, the protective plate 30 is made of a material having the substantially same thermal expansion coefficient as the flow channel forming plate 10.

A compliance plate 40 having a seal film 41 and a fixed plate 42 is bonded to a region of the protective plate 30 corresponding to the reservoir portion 32. The seal film 41 is made of a flexible material having low rigidity. The seal film 41 seals one surface of the reservoir portion 32. The fixed plate 42 is made of a hard material, such as a metal or the like. A region of the fixed plate 42 opposite the reservoir 100 is completely removed in its thickness direction to form an opening 43, and thus one surface of the reservoir 100 is sealed only by the flexible seal film 41 which has the flexibility.

In such a recording head II, ink is supplied from an external ink supply unit (not shown), and filled of ink from the reservoir 100 to the nozzles 21. A predetermined driving signal is selectively applied to a predetermined piezoelectric element 300 (the main piezoelectric element 301 and the sub piezoelectric elements 302 and 303) in accordance with a recording signal from a driving circuit (not shown). When this happens, the piezoelectric element 300 is deformed in a deflection manner. Accordingly, pressure in the corresponding pressure generation chamber 12 increases, and thus ink droplets are jet from a predetermined nozzle 21.

In the recording head II having the above-described configuration, each of the pressure generation chambers 12 includes the main pressure chamber 12a and the first and second sub pressure chambers 12b and 12c. For this reason, the nozzles 21 can be comparatively easily arranged with high density. Therefore, a stable ink ejection characteristic can be obtained and print quality can be improved. In addition, the driving frequency can be increased and thus high-speed printing can be realized.

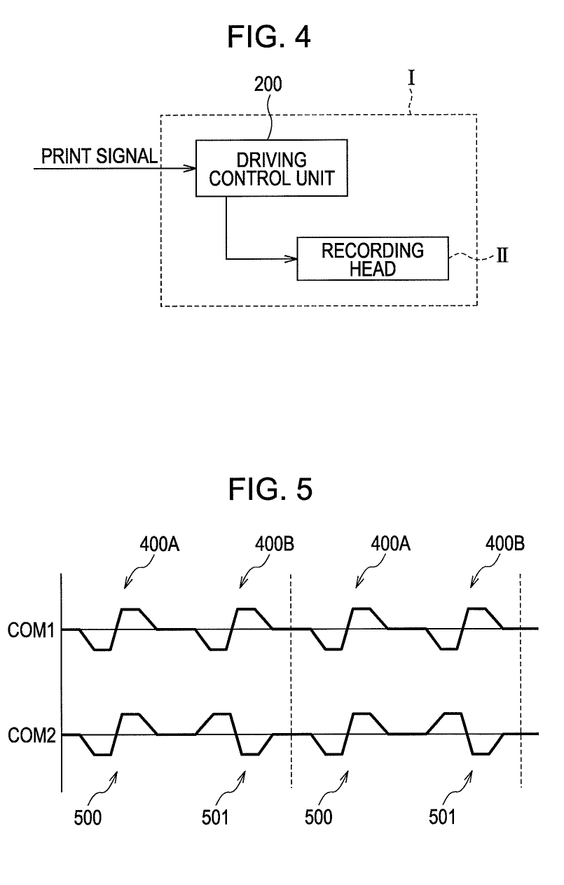

As shown in a block diagram of FIG. 4, the ink jet type recording apparatus I has a driving control unit 200 for controlling driving of the recording head II, in particular, driving of the piezoelectric elements 300 constituting the recording head II. In the invention, as described above, each of the piezoelectric elements 300 has the main piezoelectric element 301 and the sub piezoelectric elements 302 and 303. Accordingly, the driving control unit 200 selectively applies the driving signal to the main piezoelectric element 301 and the sub piezoelectric elements 302 and 303 in accordance with input of a print signal such that liquid droplets are jet from a predetermined nozzle communicating with each pressure generation chamber.

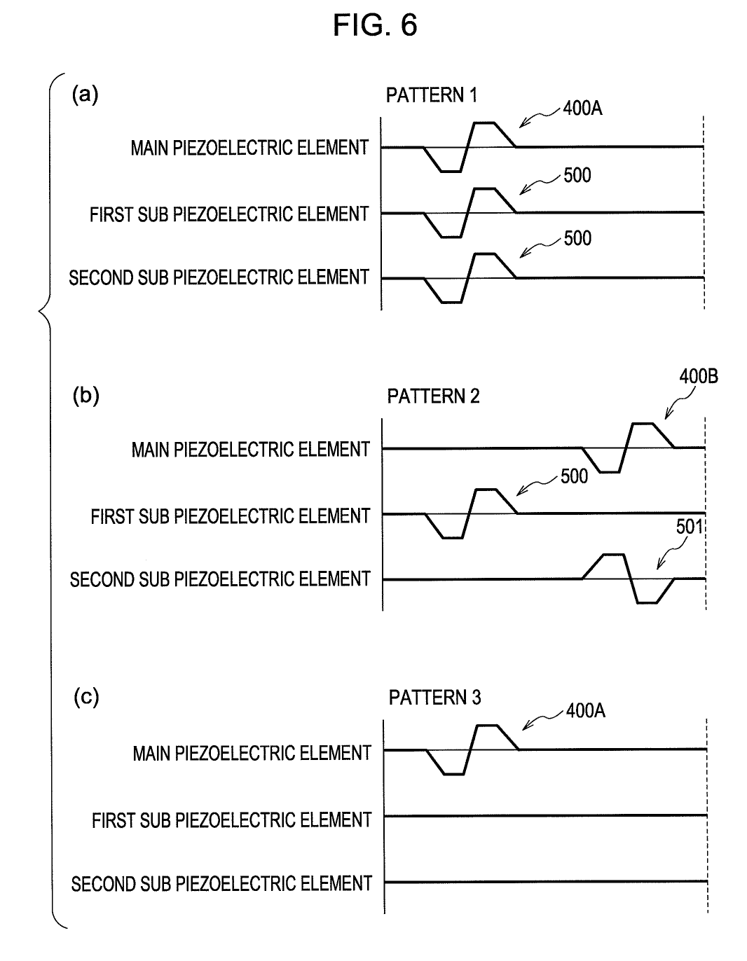

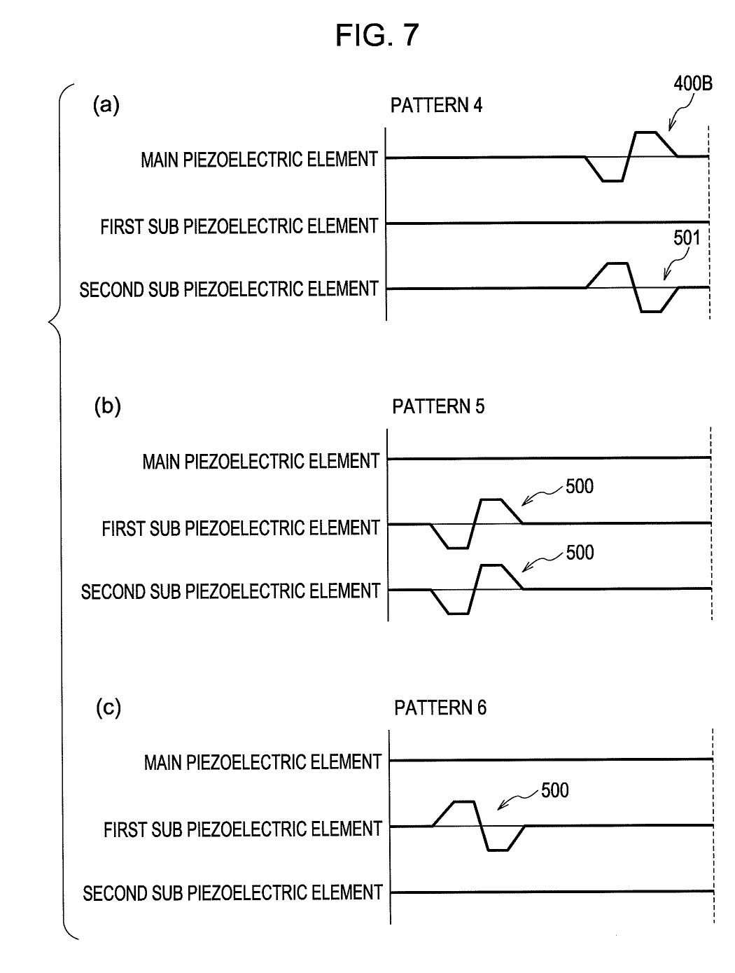

A driving method of the recording head II by the driving control unit 200 will be described. FIG. 5 is a diagram showing an example of basic driving signals which are output to the main piezoelectric element 301 and the sub piezoelectric elements 302 and 303. FIG. 6 and FIG. 7 are diagrams showing examples of patterns of driving signals which are applied to the main piezoelectric element 301 and the sub piezoelectric elements 302 and 303.

As shown in FIG. 5, the basic driving signals that are applied to the piezoelectric elements 300 include a basic driving signal (COM1) for the main piezoelectric element 301 and a basic driving signal (COM2) for the sub piezoelectric elements 302 and 303.

The basic driving signal (COM1) for the main piezoelectric element 301 has two jet driving signals 400A and 400B for jetting ink droplets from the nozzle 21 as one cycle. The basic driving signal (COM2) for the sub piezoelectric elements 302 and 303 has a jet driving signal 500 that is used to jet ink droplets from the nozzle 21, and a nonjet driving signal 501 that is in opposite phase to the jet driving signal 500 and used not to jet ink droplets from the nozzle 21. The basic driving signal (COM2) has the successive jet driving signal 500 and nonjet driving signal 501 as one cycle.

The basic driving signals (COM1 and COM2) have voltage depending on the size (width) of each piezoelectric element 300. Specifically, the basic driving signal (COM1) for the main piezoelectric element 301 has a peak voltage set so as to be lower than that of the basic driving signal (COM2) for the sub piezoelectric elements 302 and 303. This is because the main piezoelectric element 301 and the sub piezoelectric elements 302 and 303 generate adequate pressure depending on the size of each pressure generation chamber 12.

One jet driving signal in one cycle of the basic driving signal (COM1) is selectively applied to the main piezoelectric element 301. The jet driving signal 500 and the nonjet driving signal 501 in one cycle of the basic driving signal (COM2) are selectively applied to the first sub piezoelectric element 302 and the second sub piezoelectric element 303, respectively. In this way, ink droplets are jet from a predetermined nozzle 21. In this embodiment, the main piezoelectric element 301 and the sub piezoelectric elements 302 and 303 are driven in combination so as to jet ink droplets having different sizes (an ink droplet of a first size (small dot), an ink droplet of a second size larger than the first size (medium dot), and an ink droplet of a third size larger than the second size (large dot)).

Hereinafter, the patterns of the driving signals which are applied to the main piezoelectric element 301 and the sub piezoelectric elements 302 and 303 will be described.

A pattern 1 of driving signals shown in FIG. 6(a), as shown in Table 1 is an example of driving signals which are used to jet ink droplets of a large dot from a nozzle 21B communicating with the first sub pressure chamber 12b and a nozzle 21C communicating with the second sub pressure chamber 12c. Specifically, one jet driving signal 400A in one cycle selected from the basic driving signal (COM1) is applied to the main piezoelectric element 301, and the jet driving signal 500 in one cycle selected from the basic driving signal (COM2) is applied to the first and second sub piezoelectric elements 302 and 303. Accordingly, a change in pressure given to ink in the first and second sub pressure chambers 12b and 12c is maximized, and as a result, ink droplets of a large dot are jet from the nozzles 21B and 21C communicating with the first and second sub pressure chambers 12b and 12c.

TABLE 1

| Pattern | Nozzle | Ink Droplet |
|---|---|---|
| 1 | Nozzle 21B | Large |
| | Nozzle 21C | Large |
| 2 | Nozzle 21B | Large |
| | Nozzle 21C | OFF |
| 3 | Nozzle 21B | Medium |
| | Nozzle 21C | Medium |
| 4 | Nozzle 21B | Medium |
| | Nozzle 21C | OFF |
| 5 | Nozzle 21B | Small |
| | Nozzle 21C | Small |
| 6 | Nozzle 21B | Small |
| | Nozzle 21C | OFF |

A pattern 2 of driving signals shown in FIG. 6(b) is an example of driving signals which are used to jet ink droplets of a large dot only from the nozzle 21B, as shown in Table 1. That is, the jet driving signal 400B selected from the basic driving signal (COM1) is applied to the main piezoelectric element 301. In addition, the jet driving signal 500 selected from the basic driving signal (COM2) is applied to the first sub piezoelectric element 302, and the nonjet driving signal 501 is applied to the second sub piezoelectric element 303. Accordingly, a change in pressure given to ink in the first sub pressure chamber 12b is maximized, and an ink droplet of a large dot is jet from the nozzle 21B communicating with the first sub pressure chamber 12b. Meanwhile, a change in pressure of the second sub pressure chamber 12c due to displacement of the main piezoelectric element 301 is substantially cancelled by a change in pressure due to displacement of the second sub piezoelectric element 303, and thus no ink droplets are jet from the nozzle 21C.

A pattern 3 of driving signals shown in FIG. 6(c) is an example of driving signals which are used to jet ink droplets of a medium dot from the nozzles 21B and 21C, as shown in Table 1. That is, the jet driving signal 400A selected from the basic driving signal (COM1) is applied to the main piezoelectric element 301. In addition, neither the jet driving signal 500 nor the nonjet driving signal 501 is applied to the first and second sub piezoelectric elements 302 and 303. That is, the first and second sub piezoelectric elements 302 and 303 are not displaced. Accordingly, ink droplets of a medium dot are jet from the nozzles 21B and 21C due to a change in pressure of ink caused only by displacement of the main piezoelectric element 301.

A pattern 4 of driving signals shown in FIG. 7(a) is an example of driving signals which are used to jet an ink droplet of a medium dot only from the nozzle 21B, as shown in Table 1. That is, the jet driving signal 400B selected from the basic driving signal (COM1) is applied to the main piezoelectric element 301. In addition, neither the jet driving signal 500 nor the nonjet driving signal 501 is applied to the first sub piezoelectric element 302, and the nonjet driving signal 501 selected from the basic driving signal (COM2) is applied to the second sub piezoelectric element 303. Accordingly, an ink droplet of a medium dot is jet from the nozzle 21B communicating with the first sub pressure chamber 12b due to a change in pressure caused by displacement of the main piezoelectric element 301. Meanwhile, a change in pressure of the second sub pressure chamber 12c due to displacement of the main piezoelectric element 301 is substantially cancelled by a change in pressure due to displacement of the second sub piezoelectric element 303, and thus no ink droplets are jet from the nozzle 21C.

A pattern 5 of driving signals shown in FIG. 7(b) is an example of driving signals which are used to jet ink droplets of a small dot from the nozzles 21B and 21C, as shown in Table 1. Specifically, the jet driving signal 400 is not applied to the main piezoelectric element 301, and the jet driving signal 500 selected from the basic driving signal (COM2) is applied to the first and second sub piezoelectric elements 302 and 303. Accordingly, ink droplets of a small dot are jet from the nozzles 21B and 21C due to a change in pressure caused only by displacement of the first and second sub piezoelectric elements 302 and 303.

A pattern 6 of driving signals shown in FIG. 7(c) is an example of driving signals which are used to jet an ink droplet only from the nozzle 21B, as shown in Table 1. Specifically, the jet driving signal 500 selected from the basic driving signal (COM2) is applied only to the first sub piezoelectric element 302. That is, while the main piezoelectric element 301 and the second sub piezoelectric element 303 are not displaced, only the first sub piezoelectric element 302 is displaced by the jet driving signal 500. Accordingly, an ink droplet of a small dot is jet from the nozzle 21B due to a change in pressure caused by displacement of the first sub piezoelectric element 302, and no ink droplets are ejected from the nozzle 21C.

As various patterns of driving signals are illustrated, according to the driving method of the invention, ink droplets having different sizes can be jet from the nozzle 21, and thus fine printing becomes possible. Therefore, it is possible to improve print quality, and also to cope with various kinds of printing. In addition, with respect to a sub pressure chamber communicating with a nozzle which does not jet ink droplets, a nonjet driving signal in opposite phase to a jet driving signal is applied to the corresponding sub piezoelectric element, such that a change in pressure due to displacement of the main piezoelectric element 301 is cancelled by a change in pressure due to displacement of the sub piezoelectric element. As a result, ink droplets can be reliably jet from a predetermined nozzle.

The above-described patterns of driving signals are just examples, but the driving method of the invention is not limited to the examples. For example, in any cases, the jet driving signal 400B with the same timing as the jet driving signal of the basic driving signal (COM2) or the jet driving signal 400B with the same timing as the nonjet driving signal may be applied to the main piezoelectric element 301.

In this embodiment, a thin film ink jet type recording head that is manufactured by using film deposition and lithography processes has been described, but the invention is not limited thereto. For example, the driving method of the invention may be adopted for a thick film ink jet type recording head that is formed by, for example, patching a green sheet or the like.

In this embodiment, the driving method of the invention has been described with reference to an ink jet type recording head which includes pressure generation chambers each having two sub pressure chambers. However, the driving method of the invention may also be applied to an ink jet type recording head which includes pressure generation chambers each having three or more sub pressure chambers.

In this embodiment, an ink jet type recording apparatus in which an ink jet type recording head is mounted on a carriage and moves in a main scanning direction has been described, but the invention may also be applied to other types of ink jet type recording apparatuses. For example, the invention may also be applied to a so-called line-type ink jet type recording apparatus that has a plurality of fixed ink jet type recording heads and performs printing only by moving the recording sheet S, such as paper or the like, in a sub scanning direction.

In this embodiment, a case in which an ink jet type recording head is used as an example of a liquid jet head has been described. However, the invention is intended for all kinds of liquid jet heads, and of course, it may be applied to a liquid jet head that jets a liquid other than ink. Other examples of the liquid jet head include, for example, various recording heads used in an image recording apparatus, such as a printer or the like, a color material jet head used in manufacturing a color filter for a liquid crystal display or the like, an electrode material jet head used in forming electrodes for an organic EL display, an FED (Field Emission Display), or the like, a bio-organic material jet head used in manufacturing a biochip.

What is claimed is:

1. A method of driving a liquid jet head,
wherein the liquid jet head includes a plurality of nozzles jetting liquid droplets, pressure generation chambers individually communicating with the nozzles and having a predetermined width, a reservoir common to a plurality of pressure generation chambers, and piezoelectric elements, each causing a change in pressure of a corresponding one of the pressure generation chambers,
each of the pressure generation chambers includes a main pressure chamber communicating with the reservoir through a liquid supply channel, and a plurality of sub pressure chambers arranged in parallel in a width direction of the main pressure chamber, the sub pressure chambers independently communicating with an end surface of the main pressure chamber opposite to the liquid supply channel, and each of the sub pressure chambers communicating with a corresponding one of the nozzles,
each of the piezoelectric element includes a main piezoelectric element provided to correspond to the main pressure chamber, and sub piezoelectric elements provided to correspond to the sub pressure chambers and have a width smaller than that of the main piezoelectric element, and
when the main piezoelectric element is driven so as to jet liquid droplets from a predetermined nozzle, a driving signal which is in opposite phase to a driving signal to be applied to the main piezoelectric element is applied to a sub piezoelectric element corresponding to a sub pressure chamber communicating with a nozzle, which does not jet liquid droplets.

2. The method according to claim 1,
wherein the sub piezoelectric elements are separately driven so as to jet liquid droplets of a first size, the main piezoelectric element is separately driven so as to jet liquid droplets of a second size larger than the first size, and the main piezoelectric element and the sub piezoelectric elements are simultaneously driven so as to jet liquid droplets of a third size larger than the second size.

3. The method according to claim 1,
wherein the sub piezoelectric elements are driven by a voltage higher than a voltage to be applied to the main piezoelectric element.

4. A liquid jet apparatus comprising:
a liquid jet head that includes a plurality of nozzles jetting liquid droplets, pressure generation chambers individually communicating with the nozzles and having a predetermined width, a reservoir common to a plurality of pressure generation chambers, and piezoelectric elements, each causing a change in pressure of a corresponding one of the pressure generation chambers,
each of the pressure generation chambers including a main pressure chamber communicating with the reservoir through a liquid supply channel, and a plurality of sub pressure chambers arranged in parallel in a width direction of the main pressure chamber, the sub pressure chambers independently communicating with an end surface of the main pressure chamber opposite to the liquid supply channel, and each of the sub pressure chambers communicating with a corresponding one of the nozzles, and
each of the piezoelectric elements including a main piezoelectric element provided to correspond to the main pressure chamber, and sub piezoelectric elements provided to correspond to the sub pressure chambers and have a width smaller than that of the main piezoelectric element; and
a driving control unit that, when the main piezoelectric element is driven so as to jet liquid droplets from a predetermined nozzle, applies a driving signal, which is in opposite phase to a driving signal to be applied to the main piezoelectric element, to a sub piezoelectric element corresponding to a sub pressure chamber communicating with a nozzle, which does not jet liquid droplets.
